(19) United States
(12) Patent Application Publication
(10) Pub. No.: US 2026/0361436 A1
(43) Pub. Date: Nov. 12, 2026

(54) Method for modeling and simulating unmanned aerial vehicle (UAV) air-to-air channel in urban low-altitude scenario

(71) Applicant: Nanjing University of Aeronautics and Astronautics, Nanjing (CN)

(72) Inventors: Boyu HUA, Nanjing (CN); Qingzhe DENG, Nanjing (CN); Qiuming ZHU, Nanjing (CN); Zhangfeng MA, Nanjing (CN); Kai MAO, Nanjing (CN); Sheng FANG, Nanjing (CN); Liwei HAN, Nanjing (CN); Zhipeng LIN, Nanjing (CN); Yang HUANG, Nanjing (CN)

(73) Assignee: Nanjing University of Aeronautics and Astronautics, Nanjing (CN)

(21) Appl. No.: 19/340,902

(22) Filed: Sep. 26, 2025

(30) Foreign Application Priority Data
May 6, 2025 (CN) 202510571396.3

(51) Int. Cl. H04B 17/391; H04B 7/185

(52) U.S. Cl. CPC H04B 17/3912; H04B 7/18506

(57) ABSTRACT

A method for modeling and simulating an air-to-air channel between unmanned aerial vehicles (UAVs) in an urban low-altitude environment includes: calculating the delay, total phase, and power for the line-of-sight (LoS) path, rooftop reflected path, and non-line-of-sight paths based on input positional, scenario, and scatterer distribution parameters, respectively; determining the channel impulse response for each path using attitude-dependent antenna pattern functions; and integrating these components to establish a comprehensive channel model and output the channel coefficient. This approach enables efficient and accurate emulation of UAV air-to-air channels.

### CROSS REFERENCE TO THE RELATED APPLICATIONS

This application is based upon and claims priority to Chinese Patent Application No. 202510571396.3, filed on May 6, 2025, the entire contents of which are incorporated herein by reference.

### TECHNICAL FIELD

The present disclosure relates to the field of wireless information transmission, and in particular to a method for modeling and simulating an unmanned aerial vehicle (UAV) air-to-air channel in an urban low-altitude scenario.

### BACKGROUND

With the development of the fifth/sixth generations (5G/6G) of mobile communication technology and the Internet of Things (IoT), low-altitude digital infrastructure has become the key to intelligent development. Due to the technological breakthroughs in artificial intelligence (AI) and edge computing, the application of unmanned aerial vehicles (UAVs) is accelerating, especially with the increasing demands for communication in low-altitude environments. In low-altitude urban scenarios, UAVs can not only undertake tasks such as urban monitoring and logistics distribution but also play an important role in emergency communication and disaster relief. The complexity of low-altitude urban scenarios presents significant challenges to communication between UAVs, particularly as factors like dense buildings and multipath signal propagation greatly affect signal transmission. Therefore, accurate air-to-air channel modeling for low-altitude scenarios has become crucial for enhancing the communication performance of UAVs.

Currently, traditional channel models, such as terrestrial or air-to-ground models, have been extensively studied. However, air-to-air channels require new modeling methods due to their unique challenges. Unlike terrestrial or air-to-ground scenarios, in low-altitude urban environments, both the transmitter and the receiver of air-to-air communication are in the air. This characteristic alters the signal propagation properties and the distribution of scatterers in the environment. Furthermore, most air-to-ground channel models for UAVs treat the UAV as a point mass, neglecting the impact of the fuselage structure and attitude variations on the channel.

### SUMMARY

An objective of the present disclosure is to provide a method for modeling and simulating a UAV air-to-air channel in an urban low-altitude scenario. The present disclosure comprehensively considers factors such as the attitude and position changes of the UAV and the actual distribution characteristics of scatterers. This effectively improves the authenticity and accuracy of the channel model, thereby enhancing the communication quality of UAVs.

To achieve the above objective, the present disclosure adopts the following technical solution:

A method for modeling and simulating a UAV air-to-air channel in an urban low-altitude scenario includes following steps:
S1: calculating a delay, a total phase, and a power of a line-of-sight path between a transmitter and a receiver of a UAV in a channel model based on input position parameters of the transmitter and the receiver; and calculating a channel impulse response of the line-of-sight path based on an attitude-dependent antenna pattern function for the line-of-sight path;
S2: calculating a delay, a total phase, and a power of a rooftop reflected path in the channel model based on a communication scenario parameter; and calculating a channel impulse response of the rooftop reflected path based on an attitude-dependent antenna pattern function for a non-line-of-sight path;
S3: calculating a delay, a total phase, and a power of the non-line-of-sight path in the channel model based on height and horizontal geometric relationship parameters limiting a scatterer distribution; and calculating a channel impulse response of the non-line-of-sight path based on the attitude-dependent antenna pattern function for the non-line-of-sight path; and
S4: establishing a UAV air-to-air channel model, inputting calculation results from the steps S1 to S3, and outputting a channel coefficient, where the UAV air-to-air channel model is as follows:

$${h}_{p q} ( t , τ ) = \sqrt{\frac{K ( t )}{K ( t ) + 1}} {h}_{p q}^{L} ( t , τ ) + \sqrt{\frac{{η}^{RSR} ( t )}{K ( t ) + 1}} {h}_{p q}^{RSR} ( t , τ ) + \sqrt{\frac{{η}^{NL} ( t )}{K ( t ) + 1}} {h}_{p q}^{N L} ( t , τ )$$

where, h_{pq}(t,τ) denotes a channel impulse response between a p-th transmitter antenna and a q-th receiver antenna; t denotes a time; t denotes a delay; K(t) denotes a time-varying Rician factor; η^{RSR}(t) and η^{NL}(t) denote power coefficients of the rooftop reflected path and the non-line-of-sight path, respectively, satisfying η^{RSR}(t)+η^{NL}(t)=1;

$$and {h}_{pq}^{L} ( t , τ ) , {h}_{pq}^{RSR} ( t , τ ) , and {h}_{pq}^{NL} ( t , τ )$$

denote the channel impulse responses of the line-of-sight path, the rooftop reflected path, and the non-line-of-sight path, respectively.

Compared with the prior art, the present disclosure has the following beneficial effects:

Firstly, in the present disclosure, the method for modeling and simulating a UAV air-to-air channel in an urban low-altitude scenario incorporates factors such as the real scattering environment and the UAV fuselage structure. The present disclosure provides the generation and calculation methods of channel parameters at the simulation level under the conditions of three-dimensional movement of the air-to-air communication transceiver and fuselage rotation and shadowing, achieving efficient and accurate reproduction of the air-to-air channel for UAVs.

Secondly, in the present disclosure, the method for modeling and simulating a UAV air-to-air channel in an urban low-altitude scenario introduces a rooftop reflection mechanism and performs power correction based on the UAV fuselage shadowing effect. Compared to traditional standardized models, the present disclosure can more accurately characterize the non-line-of-sight propagation paths in low-altitude urban environments, compensating for the limitations of current models and improving the accuracy of channel modeling.

Thirdly, in the present disclosure, the method for modeling and simulating a UAV air-to-air channel in an urban low-altitude scenario uses a terrain statistical method to calculate parameters related to the rooftop reflected path. The present disclosure provides relevant calculation methods for non-line-of-sight path parameters, avoiding the inaccuracy of traditional methods in calculating line-of-sight path power under fuselage shadowing conditions. The present disclosure enables efficient and accurate simulation and reproduction of air-to-air channels in urban scenarios.

### BRIEF DESCRIPTION OF THE DRAWINGS

FIG. 1 is a flowchart of a method for modeling and simulating a UAV air-to-air channel in an urban low-altitude scenario in the present disclosure;

FIG. 2 is a schematic diagram of an air-to-air communication scenario for UAVs in the present disclosure;

FIG. 3 is a power delay profile of a rooftop reflected path and a non-line-of-sight path in the present disclosure;

FIG. 4 is a schematic diagram of a channel coefficient generated in first 3 seconds in the present disclosure;

FIG. 5 is a schematic diagram of a user-defined parameter input in an embodiment; and

FIG. 6 is a schematic diagram of a UAV motion parameter in the embodiment.

### DETAILED DESCRIPTION OF THE EMBODIMENTS

The embodiments of the present disclosure are further described in detail below with reference to the drawings.

The present disclosure provides a method for modeling and simulating a UAV air-to-air channel in an urban low-altitude scenario, which includes following steps.
1) A user configuration parameter is input, specifically including: a communication scenario type, a carrier frequency, an antenna type, initial position vectors and velocity vectors of a transmitter and a receiver of a UAV, and motion trajectories of the transmitter and the receiver.
2) A delay, a total phase, and a power of a line-of-sight path between the transmitter and the receiver of the UAV in a channel model are calculated based on positions of the transmitter and the receiver.
3) A delay, a total phase, and a power of a rooftop reflected path in the channel model are calculated based on a communication scenario.
4) A delay, a total phase, and a power of a non-line-of-sight path in the channel model are calculated based on a geometric relationship.
5) The UAV air-to-air channel model is established, and the parameters calculated in the steps 1) to 4) are substituted to output a channel coefficient.

The step 2) specifically includes following sub-steps.
21) Position vectors of transmitter and receiver antennas are calculated.

Positions L^{Tx/Rx}(t+Δt) of the transmitter and the receiver of the UAV at time t+Δt are calculated as follows:

$${L}^{Tx / Rx} ( t + Δ t ) = {L}^{Tx / Rx} ( t ) + {\int }_{t}^{t + Δ t} {v}^{Tx / Rx} ( {t}^{′} ) {dt}^{′} ;$$

where, v^{Tx}(t) and v_{Rx}(t) denote the velocity vectors of the transmitter and the receiver of the UAV, respectively, and are calculated as follows:

$${v}^{Tx / Rx} ( t ) = ‖ {v}^{Tx / Rx} ( t ) ‖ \cdot [ \begin{matrix}cos {ϕ}^{Tx / Rx} ( t ) cos {ϕ}^{Tx / Rx} ( t ) \\ cos {ψ}^{Tx / Rx} ( t ) sin {ϕ}^{Tx / Rx} ( t ) \\ sin {ψ}^{Tx / Rx} ( t )\end{matrix} ] ;$$

where, ∥⋅∥ denotes a modulo operation; φ^{Tx/Rx} denotes an azimuth angle of a motion velocity of the transmitter and the receiver; and ψ^{Tx/Rx} denotes a pitch angle of the motion velocity of the transmitter and receiver.

The position vectors

$${L}_{p / q}^{Tx / Rx} ( t )$$

of the transmitter antenna and the receiver antenna are expressed as:

$${L}_{p / q}^{Tx / Rx} ( t ) = {L}^{Tx / Rx} ( t ) + {e}_{p / q} ( t ) ;$$

where, eₚ(t) and e_{q}(t) denote vectors from a center of the transmitter and the receiver to p-th and q-th antenna elements, respectively.
22) The delay

$${τ}_{pq}^{L} ( t )$$

of the line-of-sight path is calculated based on the position vectors of the transmitter antenna and the receiver antenna calculated in the step 21):

$${τ}_{pq}^{L} ( t ) = \frac{{d}_{pq}^{L} ( t )}{c} = \frac{‖ {L}_{p}^{Tx} ( t ) - {L}_{q}^{Rx} ( t ) ‖}{c} ;$$

where,

$${d}_{pq}^{L} ( t )$$

denotes a length of the line-of-sight path; and c denotes a speed of electromagnetic wave propagation.
23) The total phase of the line-of-sight path is calculated.
231) Initial phase

$${Φ}_{I , pq}^{L} ( t )$$

of the line-of-sight path is calculated based on the length of the line-of-sight path calculated in the step 22):

$${Φ}_{I , pq}^{L} ( t ) = - k \cdot {d}_{pq}^{L} ( t ) ;$$

where, k=2πƒ_{c}/c denotes a wavenumber; and ƒ_{c} denotes the carrier frequency in mHz.
232) Doppler phase

$${Φ}_{D , pq}^{L} ( t )$$

of the line-of-sight path is calculated as follows:

$${Φ}_{D , pq}^{L} ( t ) = k \cdot {\int }_{0}^{t} ‖ {s}^{L , Tx} ( \tilde{t} ) ( {v}^{Tx} ( \tilde{t} ) - {v}^{Rx} ( \tilde{t} ) ) ‖ d \tilde{t} ;$$

where, s^{L,Tx}(\tilde{t}) denotes a unit vector for an angle of the line-of-sight path at the transmitter, which can be calculated by converting the azimuth angle and the pitch angle of the line-of-sight path to a Cartesian coordinate system; and the transmitter azimuth angle α^{L,Tx}, the receiver azimuth angle α^{L,Rx}, the transmitter pitch angle β^{L,Tx}, and the receiver pitch angle β^{L,Rx} are calculated as follows:

$${α}^{L , Tx} = arc sin ( \frac{{L}_{p , y}^{Tx} ( t ) - {L}_{q , y}^{Rx} ( t )}{\sqrt{{( {L}_{p , y}^{Tx} ( t ) - {L}_{q , y}^{Rx} ( t ) )}^{2} + {( {L}_{p , x}^{Tx} ( t ) - {L}_{q , x}^{Rx} ( t ) )}^{2}}} ) ;$$

$${β}^{L , Tx} = arc sin ( \frac{{L}_{p , z}^{Tx} ( t ) - {L}_{q , z}^{Rx} ( t )}{\sqrt{{( {L}_{p , y}^{Tx} ( t ) - {L}_{q , y}^{Rx} ( t ) )}^{2} + {( {L}_{p , x}^{Tx} ( t ) - {L}_{q , x}^{Rx} ( t ) )}^{2}}} ) ;$$

$${α}^{L , Rx} = π - {α}^{L , Tx} ;$$

$${β}^{L , Rx} = π - {β}^{L , Tx} ;$$

233) Antenna correction phase

$${Φ}_{A , pq}^{L} ( t )$$

of the line-of-sight path is calculated as follows:

$${Φ}_{A , pq}^{L} ( t ) = k \cdot ‖ {L}^{Tx} ( t ) {R}^{P , Tx} ( t ) {s}^{L , Tx} ( t ) + {L}^{Rx} ( t ) {P}^{P , Rx} ( t ) {s}^{L , Rx} ( t ) ‖ ;$$

where, R^{P,Tx/Rx}(t) denotes an attitude matrix of the transmitter or the receiver of the UAV, which is provided in real time by an inertial measurement unit onboard the UAV and can be modeled as:

$${R}^{P , Tx / Rx} ( t ) = [ \begin{matrix}cos ω cos φ & cos ω sin φ sin γ - sin ω cos γ & cos ω sin φ cos γ + sin ω sin γ \\ sin ω cos φ & sin ω sin φ sin γ + cos ω cos γ & sin ω sin φ cos γ - cos ω sin γ \\ - sin φ & cos φ sin γ & cos φ cos γ\end{matrix} ] ;$$

where, ω, φ, and γ denote attitude angles: a roll angle, a pitch angle, and a yaw angle, respectively.
234) The total phase

$${Φ}_{pq}^{L} ( t )$$

of the line-of-sight path is calculated based on the initial phase, the Doppler phase, and the antenna correction phase of the line-of-sight path calculated in the steps 231), 232), and 233):

$${Φ}_{pq}^{L} ( t ) = {Φ}_{I , pq}^{L} ( t ) + {Φ}_{D , pq}^{L} ( t ) + {Φ}_{A , pq}^{L} ( t ) ;$$

24) The power of the line-of-sight path is calculated.
241) Fuselage structure parameter set U is defined as:

U={Θ^{l},Θ^{b},Θ^{d},d^{a},d^{w},l^{a},l^{xy},l^{c}};
where, Θ^{l} denotes a leading edge sweep angle; Θ^{b} denotes a trailing edge sweep angle; Θ^{d} denotes a dihedral angle; d^{a} denotes a fuselage width; d^{w} denotes a wingspan; l^{a} denotes a fuselage length; l^{xy} denotes a vertical distance of an antenna from an x-y plane; and l^{c} denotes a wing chord length.
242) Position vector Lᵢ(t) of a fuselage diffraction point is calculated as follows:

$${L}_{i} ( t ) = {L}_{p / q}^{Tx / Rx} ( t ) + {e}_{p / q , i} ;$$

where, i denotes an i-th diffraction path; and e_{p/q,i} denotes a vector from the p-th transmitter antenna element or the q-th receiver antenna element to a fuselage edge, which is determined by the fuselage structure parameter set and a coordinate system.
243) Dimensionless parameter εᵢ(t) is defined to describe a signal attenuation degree:

$${ε}_{i} ( t ) = \sqrt{\frac{2 {d}_{i} ( t ) \cdot {Θ}_{i} ( t )}{λ}} ;$$

where, dᵢ(t) denotes a vertical distance from the fuselage diffraction point to a line connecting the transmitter and the receiver; and Θᵢ(t) denotes an angle (in radians) formed by the transmitter, the fuselage diffraction point, and the receiver:

$${d}_{i} ( t ) = \{ \begin{matrix}‖ {L}_{t} ( t ) - {L}^{Rx} ( t ) ‖ \cdot sin 〈 {L}_{i} ( t ) - {L}^{Rx} ( t ) , {L}^{Tx} ( t ) - {L}^{Rx} ( t ) 〉 , & {L}^{Tx} ( t ) {e}_{z} \leq {L}^{Rx} ( t ) {e}_{z} \\ ‖ {L}_{t} ( t ) - {L}^{Tx} ( t ) ‖ \cdot sin 〈 {L}_{i} ( t ) - {L}^{Tx} ( t ) , {L}^{Rx} ( t ) - {L}^{Tx} ( t ) 〉 , & {L}^{Rx} ( t ) {e}_{z} \leq {L}^{Tx} ( t ) {e}_{z}\end{matrix} ;$$

$${Θ}_{i} ( t ) = \frac{π}{180} 〈 {L}_{i} ( t ) - {L}^{Tx} ( t ) {R}^{P , Tx} ( t ) , {L}^{Rx} ( t ) {R}^{P , Rx} ( t ) - {L}_{i} ( t ) 〉 ;$$

244) Power factor

$${C}_{pq}^{L} ( t )$$

path considering a fuselage shadowing effect is calculated as follows:

$${C}_{pq}^{L} ( t ) = \{ \begin{matrix}{10}^{- ( 32.4 + 20 {lgd}_{pq}^{L} ( t ) + 20 {lgf}_{c} ) / 20} , & {ε}_{i} ( t ) < {ε}_{1} \\ {\sum }_{i} {10}^{- ( {J}_{0} + 20 lg {d}_{pq}^{L} ( t ) + 20 lg {f}_{c} + 20 l og ( \sqrt{{( {ε}_{i} ( t ) - 0.1 )}^{2} + 1} + {ε}_{i} ( t ) - 0.1 ) ) / 20} & {ε}_{1} \leq {ε}_{i} ( t ) \leq {ε}_{2} \\ 0 & others\end{matrix} ;$$

where, ε₁ and ε₂ denote thresholds determined based on a diffraction attenuation degree; and J₀ is a correction constant.

The step 3) specifically includes following sub-steps.
31) The delay of the rooftop reflected path is calculated.
311) Length

$${d}_{pq}^{RSR} ( t )$$

of the rooftop reflected path is calculated as follows:

$${d}_{pq}^{RSR} ( t ) = \sqrt{{\sum }_{j = x , y , z} {( {L}_{p , j}^{Tx} ( t ) - {L}_{j}^{RSR} ( t ) )}^{2}} + \sqrt{{\sum }_{j = x , y , x} {( {L}_{j}^{RSR} ( t ) - {L}_{q , j}^{Rx} ( t ) )}^{2}} ;$$

where,

$${L}^{RSR} ( t ) = [ \begin{matrix}{L}_{x}^{RSR} ( t ) & {L}_{y}^{RSR} ( t ) & {L}_{z}^{RSR} ( t )\end{matrix} ]$$

denotes coordinates of a rooftop reflection point; and a coordinate system is established with an x-axis as projection of the line connecting the transmitter and the receiver onto a horizontal plane, including a y-axis component being 0 and remaining components calculated based on a triangle similarity property as follows:

$${L}_{x}^{RSR} ( t ) = ( \frac{‖ {L}_{z}^{RSR} ( t ) - {L}_{q , z}^{Rx} ( t ) ‖}{‖ {L}_{p , z}^{Tx} ( t ) + {L}_{q , z}^{Rx} ( t ) - 2 {L}_{z}^{RSR} ( t ) ‖} \cdot ‖ {L}_{p , x}^{Tx} ( t ) - {L}_{q , x}^{Rx} ( t ) ‖ - ‖ {L}_{p , x}^{Tx} ( t ) ‖ ) {e}_{x} ;$$

$${L}_{z}^{RSR} ( t ) = {h}^{RSR} {e}_{z} ;$$

where, h^{RSR} denotes a height of the rooftop reflection point above a ground, with a probability density function as follows:

$$P ( {h}^{RSR} ) = \{ \begin{matrix}1 - {p}_{α} , & {h}^{RSR} = 0 \\ {p}_{α} \frac{{h}^{RSR}}{{γ}_{A}^{2}} exp ( - \frac{{( {h}^{RSR} )}^{2}}{2 {γ}_{A}^{2}} ) , & {h}^{RSR} > 0\end{matrix} ;$$

where, p_{α} denotes a proportion of land covered by a building, and γ_{A} denotes an average building height.
312) The delay

$${τ}_{pq}^{RSR} ( t )$$

is calculated based on the length of the rooftop reflected path as follows:

$${τ}_{pq}^{RSR} ( t ) = \frac{{d}_{pq}^{RSR} ( t )}{c} ;$$

32) The total phase of the rooftop reflected path is calculated as follows:
321) The initial phase

$${Φ}_{I , pq}^{RSR} ( t )$$

of the rooftop reflected path is calculated as follows:

$${Φ}_{I , pq}^{RSR} ( t ) = - k \cdot {d}_{pq}^{RSR} ( t ) ;$$

322) The Doppler phase

$${Φ}_{D , pq}^{RSR} ( t )$$

of the rooftop reflected path is calculated as follows:

$${Φ}_{D , pq}^{RSR} ( t ) = k \cdot {\int }_{0}^{t} ‖ {s}^{RSR , Tx} ( \tilde{t} ) {v}^{Tx} ( \tilde{t} ) + {s}^{RSR , Rx} ( \tilde{t} ) {v}^{Rx} ( \tilde{t} ) ‖ d \tilde{t} ;$$

where, unit direction vectors s^{RSR,Tx}(t) and s^{RSR,Rx}(t) are calculated by converting the azimuth angle and the pitch angle of the rooftop reflected path to Cartesian coordinates; and the azimuth angle α^{RSR,Tx/Rx} and the pitch angle β^{RSR,Tx/Rx} are calculated as follows:

$${α}^{RSR , Tx / Rx} = arc sin ( \frac{{L}_{y}^{RSR} ( t ) - {L}_{p , y}^{Tx / Rx} ( t )}{\sqrt{{( {L}_{x}^{RSR} ( t ) - {L}_{p / q , x}^{Tx , Rx} ( t ) )}^{2} + {( {L}_{y}^{RSR} ( t ) - {L}_{p / q , y}^{Tx / Rx} ( t ) )}^{2}}} ) ;$$

$${β}^{RSR , Tx / Rx} = arc tan ( \frac{{L}_{z}^{RSR} ( t ) - {L}_{p / q , z}^{Tx / Rx} ( t )}{\sqrt{{( {L}_{x}^{RSR} ( t ) - {L}_{p / q , x}^{Tx , Rx} ( t ) )}^{2} + {( {L}_{y}^{RSR} ( t ) - {L}_{p / q , y}^{Tx / Rx} ( t ) )}^{2}}} ) ;$$

323) The antenna correction phase

$${Φ}_{A , pq}^{RSR} ( t )$$

of the rooftop reflected path is calculated as follows:

$${Φ}_{A , pq}^{RSR} ( t ) = k \cdot ‖ {L}^{Tx} ( t ) {R}^{P , Tx} ( t ) {s}^{RSR , Tx} ( t ) + {L}^{Rx} ( t ) {R}^{P , Rx} ( t ) {s}^{RSR , Rx} ( t ) ‖ ;$$

324) The total phase

$${Φ}_{pq}^{RSR} ( t )$$

of the rooftop reflected path is calculated based on the initial phase, the Doppler phase, and the antenna correction phase calculated in the steps 321), 322), and 323):

$${Φ}_{pq}^{RSR} ( t ) = {Φ}_{I , pq}^{RSR} ( t ) + {Φ}_{D , pq}^{RSR} ( t ) + {Φ}_{A , pq}^{RSR} ( t ) ;$$

33) Power factor

$${C}_{pq}^{RSR} ( t )$$

of the rooftop reflected path is calculated as follows:

$${C}_{pq}^{RSR} ( t ) = {Γ}^{RSR} ( t ) {10}^{- ( 32.4 + 20 {lgd}_{pq}^{RSR} ( t ) + 20 {lgf}_{c} ) / 20} ;$$

where, Γ^{RSR}(t) denotes a complex reflection coefficient, calculated as follows:

$${Γ}^{RSR} ( t ) = \frac{cos {β}^{RSR , Tx} ( t ) + {k}_{η} \sqrt{η - {( sin {β}^{RSR , Tx} ( t ) )}^{2}}}{cos {β}^{RSR , Tx} ( t ) - {k}_{η} \sqrt{η - {( sin {β}^{RSR , Tx} ( t ) )}^{2}}} ;$$

where, k_{q} denotes a polarization correlation coefficient following k_{η}∈{1/η,1}, η being a relative permittivity of the reflective material.

The step 4 specifically includes following sub-steps.
41) The delay of the non-line-of-sight path is calculated as follows:
411) Length d_{pq,n}_{ₘ}(t) of an m-th sub-path of an n-th non-line-of-sight path is calculated as follows:

$${d}_{pq , {n}_{m}} ( t ) = ‖ {L}_{p}^{Tx} ( t ) - {L}_{{n}_{m}} ( t ) ‖ + ‖ {L}_{q}^{Rx} ( t ) - {L}_{{n}_{m}} ( t ) ‖ ;$$

where, Lₙ_{ₘ}(t) denotes a coordinate vector of a scattering point, which is denoted as Lₙ_{ₘ}(t)=[L_{x,n}_{ₘ}(t), L_{y,n}_{ₘ}(t), L_{z,n}_{ₘ}(t)] and calculated as follows:

$$\{ \begin{matrix}\sqrt{{( {L}_{x , {n}_{m}} ( t ) )}^{2} + {( {L}_{y , {n}_{m}} ( t ) )}^{2}} = R \\ ‖ {L}_{z , {n}_{m}} ( t ) ‖ = H , H \leq max \{ {L}^{Tx} ( t ) , {L}^{Rx} ( t ) \}\end{matrix} ;$$

where, R denotes a horizontal distance parameter limiting a scatterer distribution; and H denotes a vertical distance parameter limiting the scatterer distribution.
412) Delay

$${τ}_{pq , {n}_{m}}^{NL} ( t )$$

of the m-th sub-path of the n-th non-line-of-sight path is calculated as follows:

$${τ}_{pq , {n}_{m}}^{NL} ( t ) = \frac{{d}_{pq , {n}_{m}} ( t )}{c} ;$$

42) The total phase of the m-th sub-path of the n-th non-line-of-sight path is calculated as follows:
421) Initial phase Φ_{I,pq,n}_{ₘ}(t) of the m-th sub-path of the n-th non-line-of-sight path is calculated as follows:

Φ_{I,pq,n}_{ₘ}(t)=−k·d_{pq,n}_{ₘ}(t);
422) Doppler phase Φ_{D,pq,n}_{ₘ}(t) of the m-th sub-path of the n-th non-line-of-sight path is calculated as follows:

$${Φ}_{D , pq , {n}_{m}} ( t ) = k \cdot {\int }_{0}^{t} ‖ {s}_{{n}_{m}}^{Tx} ( \tilde{t} ) {v}^{Tx} ( \tilde{t} ) + {s}_{{n}_{m}}^{Rx} ( \tilde{t} ) {v}^{Rx} ( \tilde{t} ) ‖ d \tilde{t} ;$$

where,

$${s}_{{n}_{m}}^{Tx / Rx} ( t )$$

denotes a unit vector for an angle of the m-th sub-path of the n-th non-line-of-sight path at the transmitter or the receiver, which is calculated by converting the azimuth angle and the pitch angle to the Cartesian coordinate system; and the azimuth angle

$${α}_{{n}_{m}}^{Tx / Rx}$$

and the pitch angle

$${β}_{{n}_{m}}^{Tx / Rx}$$

are calculated as follows:

$${α}_{{n}_{m}}^{Tx / Rx} = arc sin ( \frac{{L}_{p / q , y}^{Tx / Rx} ( t ) - {L}_{y , {n}_{m}} ( t )}{\sqrt{{( {L}_{p , y}^{Tx} ( t ) - {L}_{y , {n}_{m}} ( t ) )}^{2} + {( {L}_{p , x}^{Tx} ( t ) - {L}_{x , {n}_{m}} ( t ) )}^{2}}} ) ;$$

$${β}_{{n}_{m}}^{Tx / Rx} = arc tan ( \frac{{L}_{p / q , z}^{Tx / Rx} ( t ) - {L}_{z , {n}_{m}} ( t )}{\sqrt{{( {L}_{p , y}^{Tx} ( t ) - {L}_{y , {n}_{m}} ( t ) )}^{2} + {( {L}_{p , x}^{Tx} ( t ) - {L}_{x , {n}_{m}} ( t ) )}^{2}}} ) ;$$

423) Antenna correction phase Φ_{A,pq,n}_{ₘ}(t) of the m-th sub-path of the n-th non-line-of-sight path is calculated as follows:

$${Φ}_{A , pq , {n}_{m}} ( t ) = k \cdot ‖ {L}^{Tx} ( t ) {R}^{P , Tx} ( t ) {s}_{{n}_{m}}^{Tx} ( t ) + {L}^{Rx} ( t ) {R}^{P , Rx} ( t ) {s}_{{n}_{m}}^{Rx} ( t ) ‖ ;$$

424) The total phase Φ_{pq,n}_{ₘ}(t) of the m-th sub-path of the n-th non-line-of-sight path is calculated based on the initial phase, the Doppler phase, and the antenna correction phase calculated in the steps 421), 422), and 423):

Φ_{pq,n}_{ₘ}(t)=Φ_{I,pq,n}_{ₘ}(t)+Φ_{D,pq,n}_{ₘ}(t)+Φ_{A,pq,n}_{ₘ}(t);
43) Original power factor

$${\tilde{C}}_{pq , {n}_{m}}^{NL} ( t )$$

of the non-line-of-sight path is calculated as follows:

$${\tilde{C}}_{pq , {n}_{m}}^{NL} ( t ) = exp ( - {τ}_{pq , {n}_{m}}^{NL} ( t ) \frac{{r}_{τ} - 1}{{r}_{τ} {σ}_{τ}} ) {10}^{- {SF}_{c} / 10} ;$$

where, r_{τ} denotes a delay scalar; σ_{τ} denotes a delay spread; SF_{c} denotes cluster shadow fading following a Gaussian distribution; and the power factor

$${\tilde{C}}_{pq , {n}_{m}}^{NL} ( t )$$

of the non-line-of-sight path is calculated as follows:

$${\tilde{C}}_{pq , {n}_{m}}^{NL} ( t ) = {\tilde{C}}_{pq , {n}_{m}}^{NL} ( t ) / {\sum }_{n = 1}^{N} {\sum }_{m = 1}^{M} {\tilde{C}}_{pq , {n}_{m}}^{NL} ( t ) ;$$

The step 5) specifically includes following sub-steps.

The UAV air-to-air channel model in the low-altitude scenarios is constructed as follows:

$${h}_{pq} ( t , τ ) = \sqrt{\frac{K ( t )}{K ( t ) + 1}} {h}_{pq}^{L} ( t , τ ) + \sqrt{\frac{{η}^{RSR} ( t )}{K ( t ) + 1}} {h}_{pq}^{RSR} ( t , τ ) + \sqrt{\frac{{η}^{NL} ( t )}{K ( t ) + 1}} {h}_{pq}^{NL} ( t , τ ) ;$$

where, h_{pq}(t,τ) denotes a channel impulse response between the p-th transmitter antenna and the q-th receiver antenna; t denotes a time; t denotes a delay; K(t) denotes a time-varying Rician factor; η^{RSR}(t) and η^{NL}(t) denote power coefficients of the rooftop reflected path and another non-line-of-sight path, respectively, satisfying η^{RSR}(t)+η^{NL}(t)=1; and

$${h}_{pq}^{L} ( t , τ ) , {h}_{pq}^{RSR} ( t , τ ) , and {h}_{pq}^{NL} ( t , τ )$$

denote channel impulse responses of the line-of-sight path, the rooftop reflected path, and another non-line-of-sight path, respectively, and are specifically expressed as follows:

$${h}_{pq}^{L} ( t ) = {F}_{pq}^{L} ( t ) {C}_{pq}^{L} ( t ) {e}^{j {Φ}_{pq}^{L} ( t )} δ ( τ - {τ}_{pq}^{L} ( t ) ) ;$$

$${h}_{pq}^{RSR} ( t ) = {F}_{pq}^{NL} ( t ) {C}_{pq}^{RSR} ( t ) {e}^{j {Φ}_{pq}^{RSR} ( t )} δ ( τ - {τ}_{pq}^{RSR} ( t ) ) ;$$

$${h}_{pq , {n}_{m}}^{NL} ( t ) = {F}_{pq}^{NL} ( t ) {\sum }_{n = 1}^{N} {\sum }_{m = 1}^{M} {C}_{pq , {n}_{m}}^{NL} ( t ) {e}^{j {Φ}_{pq , {n}_{m}}^{NL} ( t )} δ ( τ - {τ}_{pq , {n}_{m}}^{NL} ( t ) ) ;$$

where, N denotes a number of non-line-of-sight paths; M denotes a number of sub-paths;

$${C}_{pq}^{L} ( t ) , {C}_{pq}^{RSR} ( t ) , and {C}_{pq , {n}_{m}}^{NL} ( t )$$

denote power factors;

$${Φ}_{pq}^{L} ( t ) ,$$

$${Φ}_{pq}^{RSR} ( t ) ,$$

$$and$$

$${Φ}_{pq , {n}_{m}}^{NL} ( t )$$

denote a phase component of the propagation path;

$${τ}_{pq}^{L} ( t ) ,$$

$${τ}_{pq}^{RSR} ( t ) ,$$

$$and$$

$${τ}_{pq , {n}_{m}}^{NL} ( t )$$

denote the corresponding delays; and

$${F}_{pq}^{L} ( t )$$

$$and$$

$${F}_{pq}^{NL} ( t )$$

denote attitude-dependent antenna pattern functions, calculated as follows:

$${F}_{pq}^{L} ( t ) = {[ \begin{matrix}{F}_{p , V}^{Tx} ( {s}^{L , Tx} ( t ) , {R}^{P , Tx} ( t ) ) \\ {F}_{p , H}^{Tx} ( {s}^{L , Tx} ( t ) , {R}^{P , Tx} ( t ) )\end{matrix} ]}^{T} [ \begin{matrix}{e}^{j {Φ}_{L}^{VV}} & 0 \\ 0 & {e}^{j {Φ}_{L}^{HH}}\end{matrix} ] [ \begin{matrix}{F}_{q , V}^{Rx} ( {s}^{L , Rx} ( t ) , {R}^{P , Rx} ( t ) ) \\ {F}_{q , H}^{Rx} ( {s}^{L , Rx} ( t ) , {R}^{P , Rx} ( t ) )\end{matrix} ] ;$$

$${F}_{pq}^{NL} ( t ) = {[ \begin{matrix}{F}_{p , V}^{Tx} ( {s}_{{n}_{m}}^{Tx} ( t ) , {R}^{P , Tx} ( t ) ) \\ {F}_{p , H}^{Tx} ( {s}_{{n}_{m}}^{Tx} ( t ) , {R}^{P , Tx} ( t ) )\end{matrix} ]}^{T} [ \begin{matrix}{e}^{j {Φ}_{{n}_{m}}^{VV}} & \sqrt{{κ}_{{n}_{m}}^{- 1}} {e}^{j {Φ}_{{n}_{m}}^{VH}} \\ \sqrt{{κ}_{{n}_{m}}^{- 1}} {e}^{j {Φ}_{{n}_{m}}^{HV}} & {e}^{j {Φ}_{{n}_{m}}^{HH}}\end{matrix} ] [ \begin{matrix}{F}_{q , V}^{Rx} ( {s}_{{n}_{m}}^{Rx} ( t ) , {R}^{P , Rx} ( t ) ) \\ {F}_{q , H}^{Rx} ( {s}_{{n}_{m}}^{Rx} ( t ) , {R}^{P , Rx} ( t ) )\end{matrix} ] ;$$

where,

$${F}_{p / q , V}^{Tx / Rx} ( \cdot )$$

$$and$$

$${F}_{p / q , H}^{Tx / Rx} ( \cdot )$$

denote antenna pattern components of the transmitter or the receiver in a vertical plane and a horizontal plane, respectively;

$${Φ}_{L / {n}_{m}}^{VV} ,$$

$${Φ}_{L / {n}_{m}}^{HH} ,$$

$${Φ}_{L / {n}_{m}}^{VH} ,$$

$$and$$

$${Φ}_{L / {n}_{m}}^{HV}$$

denote initial phases of different polarization combinations, configured to describe polarization phase changes of the line-of-sight path and the non-line-of-sight path; [symbol] denotes a cross-polarization power ratio; and R^{P,TX/Rx}(t) denotes an attitude matrix of the transmitter or the receiver of the UAV, defined in the step (233).

### Embodiment

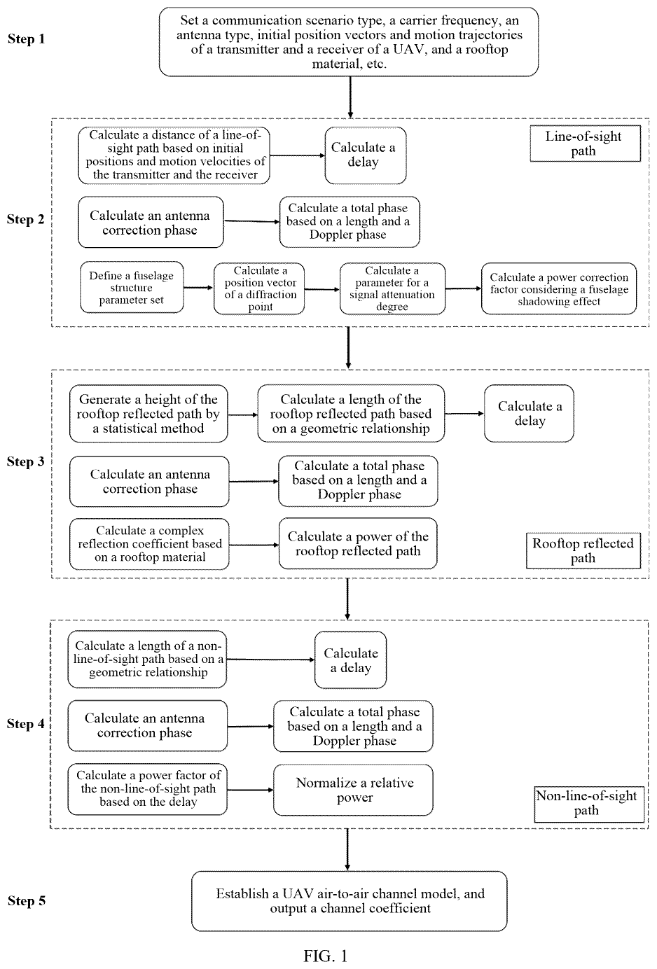

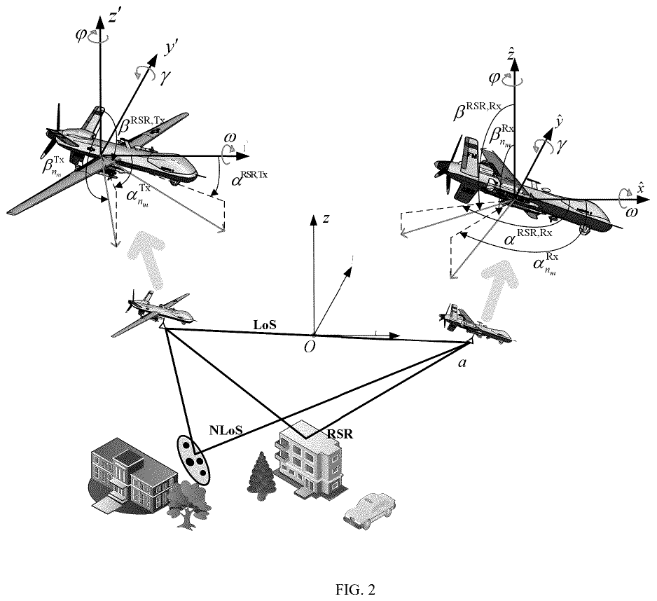

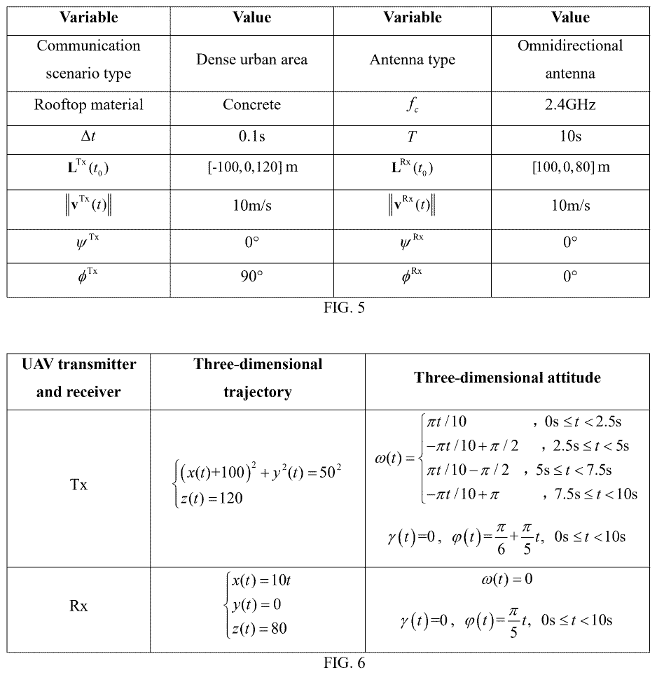

Referring to FIG. 1 and FIG. 2, in an embodiment of the present disclosure, a method for modeling and simulating a UAV air-to-air channel in an urban low-altitude scenario specifically includes following steps.
1) A user-defined parameter is input, specifically including: a communication scenario type, initial position vectors of a transmitter and a receiver of a UAV, a velocity, a three-dimensional motion trajectory, an azimuth angle and a pitch angle of a motion direction, a carrier frequency, an antenna type, a rooftop material, a simulation time, a channel state update interval, etc. The specific parameters are shown in FIG. 5 and FIG. 6.
2) A delay, a total phase, and a power of a line-of-sight path are calculated.
21) Position vectors of transmitter and receiver antennas are calculated.

Positions L^{Tx/Rx}(t+Δt) of the transmitter and the receiver of the UAV at time t+Δt are calculated based on input initial position and velocity information of the UAV:

$${L}^{Tx / Rx} ( t + Δ t ) = {L}^{Tx / Rx} ( t ) + {\int }_{t}^{t + Δ t} {v}^{Tx / Rx} ( {t}^{′} ) {dt}^{′} ;$$

where, v^{Tx}(t) and v^{Rx}(t) denote velocity vectors of the transmitter and the receiver of the UAV, respectively, expressed as:

$${v}^{Tx / Rx} ( t ) = ‖ {v}^{Tx / Rx} ( t ) ‖ \cdot [ \begin{matrix}cos {ϕ}^{Tx / Rx} ( t ) cos {ϕ}^{Tx / Rx} ( t ) \\ cos {ψ}^{Tx / Rx} ( t ) sin {ϕ}^{Tx / Rx} ( t ) \\ sin {ψ}^{Tx / Rx} ( t )\end{matrix} ] ;$$

where, ∥⋅∥ denotes a modulo operation; φ^{Tx/Rx} and ψ^{Tx/Rx} denote an azimuth angle and a pitch angle of a motion velocity; and velocity vectors at an initial time are expressed as follows:

$${v}^{Tx} = 10 \cdot [ \begin{matrix}0 \\ 1 \\ 0\end{matrix} ] ;$$

$${v}^{Rx} = 10 \cdot [ \begin{matrix}1 \\ 0 \\ 0\end{matrix} ] ;$$

The position vectors

$${L}_{p / q}^{Tx / Rx} ( t )$$

of the transmitter antenna and the receiver antenna are calculated as:

$${L}_{p / q}^{Tx / Rx} ( t ) = {L}^{Tx / Rx} ( t ) + {e}_{p / q} ( t ) ;$$

where, eₚ(t) denotes a vector from a center of the transmitter to a p-th antenna element; and e_{q}(t) denotes a vector from a center of the receiver to a q-th antenna element.
22) The delay

$${τ}_{pq}^{L} ( t )$$

of the line-or-sight path is calculated based on the position vectors of the transmitter antenna and the receiver antenna calculated in the step 21):

$${τ}_{pq}^{L} ( t ) = \frac{{d}_{pq}^{L} ( t )}{c} = \frac{‖ {L}_{p}^{Tx} ( t ) - {L}_{q}^{Rx} ( t ) ‖}{c} ;$$

where

$${d}_{pq}^{L} ( t )$$

denotes a length of the line-of-sight path; and c denotes a speed of electromagnetic wave propagation, which is 3×10⁸ m/s.
23) The total phase of the line-of-sight path is calculated.
231) Initial phase

$${Φ}_{I , pq}^{L} ( t )$$

of the line-of-sight path is calculated based on the length of the line-of-sight path calculated in the step 22):

$${Φ}_{I , pq}^{L} ( t ) = - 50.27 {d}_{pq}^{L} ( t ) ;$$

232) Doppler phase

$${Φ}_{D , pq}^{L} ( t )$$

of the line-of-sight path is calculated as follows:

$${Φ}_{D , pq}^{L} ( t ) = 50.27 {\int }_{0}^{t} ‖ {s}^{L , Tx} ( \tilde{t} ) ( {v}^{Tx} ( \tilde{t} ) - {v}^{Rx} ( \tilde{t} ) ) ‖ d \tilde{t} ;$$

where, unit direction vector s^{L,Tx}(t) is calculated by converting the azimuth angle and the pitch angle of the line-of-sight path to Cartesian coordinates.
233) Antenna correction phase

$${Φ}_{A , pq}^{L} ( t )$$

of the line-or-sight path is calculated as follows:

$${Φ}_{A , pq}^{L} ( t ) = 50.27 ‖ {L}^{Tx} ( t ) {R}^{P , Tx} ( t ) {s}^{L , Tx} ( t ) + {L}^{Rx} ( t ) {R}^{P , Rx} ( t ) {s}^{L , Rx} ( t ) ‖ ;$$

For example, when the simulation time is 2.5 s, the attitude matrices of the transmitter and the receiver are calculated as follows:

$${R}^{P , Tx} ( t ) = [ \begin{matrix}- \frac{\sqrt{2}}{4} & - \frac{\sqrt{2}}{2} & \frac{\sqrt{6}}{4} \\ - \frac{\sqrt{2}}{4} & \frac{\sqrt{2}}{2} & \frac{\sqrt{6}}{4} \\ - \frac{\sqrt{3}}{2} & 0 & - \frac{1}{2}\end{matrix} ] ; {R}^{P , Rx} ( t ) = [ \begin{matrix}0 & 0 & 0 \\ 0 & 1 & 0 \\ - 1 & 0 & 0\end{matrix} ] ;$$

234) The total phase

$${Φ}_{pq}^{L} ( t )$$

of the line-of-sight path is calculated based on the initial phase, the Doppler phase, and the antenna correction phase of the line-of-sight path calculated in the steps 231), 232), and 233):

$${Φ}_{pq}^{L} ( t ) = {Φ}_{I , pq}^{L} ( t ) + {Φ}_{D , pq}^{L} ( t ) + {Φ}_{A , pq}^{L} ( t ) ;$$

24) The power of the line-of-sight path is calculated.
241) Fuselage structure parameter set U is defined as:

U={Θ^{l},Θ^{b},Θ^{d},d^{a},d^{w},l^{a},l^{xy},l^{c}};
where, Θ^{l} denotes a leading edge sweep angle; Θ^{b} denotes a trailing edge sweep angle; Od denotes a dihedral angle; d^{a} denotes a fuselage width; d^{w} denotes a wingspan; l^{a} denotes a fuselage length; l^{xy} denotes a vertical distance of an antenna from an x-y plane; and l^{c} denotes a wing chord length. Values of these parameters are provided in U={30°,20°,5°,0.4 m, 2 m, 2 m, 0.2 m, 0.3 m}.
242) The position vector Lᵢ(t) of the fuselage diffraction point is determined by the fuselage structure parameter set and the position vector of the UAV antenna in step 21):

$${L}_{i} ( t ) = {L}_{p / q}^{Tx / Rx} ( t ) + {e}_{p / q , i} ;$$

where, i denotes an i-th diffraction path; and e_{p/q,i} denotes a vector from the transmitter antenna element or the receiver antenna element to a fuselage edge.
243) Dimensionless parameter εᵢ(t) is defined to describe a signal attenuation degree:

$${ε}_{i} ( t ) = \sqrt{\frac{2 {d}_{i} ( t ) \cdot {Θ}_{i} ( t )}{λ}} ;$$

where, dᵢ(t) denotes a vertical distance from the fuselage diffraction point to a line connecting the transmitter and the receiver; and Θᵢ(t) denotes an angle (in radians) formed by the transmitter, the fuselage diffraction point, and the receiver:

$${d}_{i} ( t ) = \{ \begin{matrix}‖ {L}_{i} ( t ) - {L}^{Rx} ( t ) ‖ \cdot sin 〈 {L}_{i} ( t ) - {L}^{Rx} ( t ) , {L}^{Tx} ( t ) - {L}^{Rx} ( t ) 〉 , & {L}^{Tx} ( t ) {e}_{z} \leq {L}^{Rx} ( t ) {e}_{z} \\ ‖ {L}_{i} ( t ) - {L}^{Tx} ( t ) ‖ \cdot sin 〈 {L}_{i} ( t ) - {L}^{Tx} ( t ) , {L}^{Rx} ( t ) - {L}^{Tx} ( t ) 〉 , & {L}^{Rx} ( t ) {e}_{z} \leq {L}^{Tx} ( t ) {e}_{z}\end{matrix} ;$$

$${Θ}_{i} ( t ) = \frac{π}{180} 〈 {L}_{i} ( t ) - {L}^{Tx} ( t ) {R}^{P , Tx} ( t ) , {L}^{Rx} ( t ) {R}^{P , Rx} ( t ) - {L}_{i} ( t ) 〉$$

$${Θ}_{i} ( t ) = \frac{π}{180} 〈 {L}_{i} ( t ) - {L}^{Tx} ( t ) {R}^{P , Tx} , {L}^{Rx} ( t ) {R}^{P , Rx} - {L}_{i} ( t ) 〉 ;$$

244) Power factor

$${C}_{pq}^{L} ( t )$$

of the line-of-sight path considering a fuselage shadowing effect is calculated as follows:

$${C}_{pq}^{L} ( t ) = \{ \begin{matrix}{10}^{- ( 32.4 + 20 {lgd}_{pq}^{L} ( t ) + 20 {lgf}_{c} ) / 20} , & {ε}_{i} ( t ) < - 0.78 \\ {\sum }_{i} {10}^{- ( {J}_{0} + 20 {lgd}_{pq}^{L} ( t ) + 20 {lgf}_{c} + 20 lo g ( \sqrt{{( {ε}_{i} ( t ) - 0.1 )}^{2} + 1} + {ε}_{i} ( t ) - 0.1 ) ) / 20} , & - 0.78 \leq {ε}_{i} ( t ) \leq 2 \\ 0 & Others\end{matrix} .$$

The step 3) specifically includes following sub-steps.
31) The delay of the rooftop reflected path is calculated.
311) Length

$${d}_{pq}^{RSR} ( t )$$

of the rooftop reflected path is calculated as follows:

$${d}_{pq}^{RSR} ( t ) = \sqrt{{\sum }_{i = x , y , z} {( {L}_{p , i}^{Tx} ( t ) - {L}_{i}^{RSR} ( t ) )}^{2}} + \sqrt{{\sum }_{i = x , y , z} {( {L}_{i}^{RSR} ( t ) - {L}_{q , i}^{Rx} ( t ) )}^{2}} ;$$

where,

$${L}^{RSR} ( t ) = [ \begin{matrix}{L}_{x}^{RSR} ( t ) & {L}_{y}^{RSR} ( t ) & {L}_{z}^{RSR} ( t )\end{matrix} ]$$

denotes coordinates of a rooftop reflection point; and a coordinate system is established with an x-axis as projection of the line connecting the transmitter and the receiver onto a horizontal plane, including a y-axis component being 0 and remaining components calculated based on a triangle similarity property as follows:

$${L}_{x}^{RSR} ( t ) = ( \frac{‖ {L}_{z}^{RSR} ( t ) - {L}_{q , z}^{Rx} ( t ) ‖}{‖ {L}_{p , z}^{Tx} ( t ) + {L}_{q , z}^{Rx} ( t ) - 2 {L}_{z}^{RSR} ( t ) ‖} \cdot ‖ {L}_{p , x}^{Tx} ( t ) - {L}_{q , x}^{Rx} ( t ) ‖ - ‖ {L}_{p , x}^{Tx} ( t ) ‖ ) {e}_{x} ;$$

$${L}_{z}^{RSR} ( t ) = {h}^{RSR} {e}_{z} ;$$

where, h^{RSR} denotes a height of the rooftop reflection point above a ground; and h^{RSR} generated by a statistical method, with a probability density function as follows:

$$P ( {h}^{RSR} ) = \{ \begin{matrix}0.5 , & {h}^{RSR} = 0 \\ 0.5 \frac{{h}^{RSR}}{{( 62.6657 )}^{2}} exp ( - \frac{{( {h}^{RSR} )}^{2}}{2 \times {( 62.6657 )}^{2}} ) , & {h}^{RSR} > 0\end{matrix} ;$$

312) The delay

$${τ}_{pq}^{RSR} ( t )$$

is calculated based on the length of the rooftop reflected path calculated in the step 311) as follows:

$${τ}_{pq}^{RSR} ( t ) = \frac{{d}_{pq}^{RSR} ( t )}{c} ;$$

32) The total phase of the rooftop reflected path is calculated as follows:
321) Initial phase

$${Φ}_{I , pq}^{RSR} ( t )$$

of the rooftop reflected path is calculated based on the length calculated in the step 311):

$${Φ}_{I , pq}^{RSR} ( t ) = - 50.27 {d}_{pq}^{RSR} ( t ) ;$$

322) The Doppler phase

$${Φ}_{D , pq}^{RSR} ( t )$$

of the rooftop reflected path is calculated as follows:

$${Φ}_{D , pq}^{RSR} ( t ) = 50.27 {\int }_{0}^{t} ‖ {s}^{RSR , Tx} ( \tilde{t} ) {v}^{Tx} ( \tilde{t} ) + {s}^{RSR , Rx} ( \tilde{t} ) {v}^{Rx} ( \tilde{t} ) ‖ d \tilde{t} ;$$

The antenna correction phase

$${Φ}_{A , pq}^{RSR} ( t )$$

of the rooftop reflected path is calculated as follows:

$${Φ}_{A , pq}^{RSR} ( t ) = 50.27 ‖ {L}^{Tx} ( t ) {R}^{P , Tx} ( t ) {s}^{RSR , Tx} ( t ) + {L}^{Rx} ( t ) {R}^{P , Rx} ( t ) {s}^{RSR , Rx} ( t ) ‖ ;$$

324) The total phase

$${Φ}_{pq}^{RSR} ( t )$$

of the rooftop reflected path is calculated based on the initial phase, the Doppler phase, and the antenna correction phase calculated in the steps 321), 322), and 323):

$${Φ}_{pq}^{RSR} ( t ) = {Φ}_{I , pq}^{RSR} ( t ) + {Φ}_{D , pq}^{RSR} ( t ) + {Φ}_{A , pq}^{RSR} ( t ) ;$$

33) Power factor

$${C}_{pq}^{RSR} ( t )$$

of the rooftop reflected path is calculated as follows:

$${C}_{pq}^{RSR} ( t ) = 0.35 \times {10}^{- ( 32.4 + 20 {lgd}_{pq}^{RSR} ( t ) + 20 {lgf}_{c} ) / 20} .$$

The step 4 specifically includes following sub-steps.
41) Delay of the m-th sub-path of the n-th non-line-of-sight path is calculated as follows:
411) Length d_{pq,n}_{ₘ}(t) of the m-th sub-path of the n-th non-line-of-sight path is calculated as follows:

$${d}_{pq , {n}_{m}} ( t ) = ‖ {L}_{p}^{Tx} ( t ) - {L}_{{n}_{m}} ( t ) ‖ + ‖ {L}_{q}^{Rx} ( t ) - {L}_{{n}_{m}} ( t ) ‖ ;$$

where, Lₙ_{ₘ}(t) denotes a coordinate vector of a scattering point, which is denoted as Lₙ_{ₘ}(t)=[L_{x,n}_{ₘ}(t),L_{y,n}_{ₘ}(t),L_{z,n}_{ₘ}(t)] and calculated as follows:

$$\{ \begin{matrix}\sqrt{{( {L}_{x , {n}_{m}} ( t ) )}^{2} + {( {L}_{y , {n}_{m}} ( t ) )}^{2}} = 200 \\ ‖ {L}_{z , {n}_{m}} ( t ) ‖ = 50 ,\end{matrix} ;$$

412) Delay of the m-th sub-path of the n-th non-line-of-sight path is calculated as follows:

$${τ}_{pq , {n}_{m}}^{NL} ( t ) = \frac{{d}_{pq , {n}_{m}} ( t )}{c} ;$$

42) The total phase of the m-th sub-path of the n-th non-line-of-sight path is calculated as follows:
421) Initial phase Φ_{I,pq,n}_{ₘ}(t) of the m-th sub-path of the n-th non-line-of-sight path is calculated based on the length calculated in the step 411) as follows:

Φ_{I,pq,n}_{ₘ}(t)=−50.27d_{pq,n}_{ₘ}(t);
422) Doppler phase Φ_{D,pq,n}_{ₘ}(t) of the m-th sub-path of the n-th non-line-of-sight path is calculated as follows:

$${Φ}_{D , pq , {n}_{m}} ( t ) = 50 \text{.27} {\int }_{0}^{t} ‖ {s}_{{n}_{m}}^{Tx} ( \tilde{t} ) {v}^{Tx} ( \tilde{t} ) + {s}_{{n}_{m}}^{Rx} ( \tilde{t} ) {v}^{Rx} ( \tilde{t} ) ‖ d \tilde{t} ;$$

423) Antenna correction phase Φ_{A,pq,n}_{ₘ}(t) of the m-th sub-path of the n-th non-line-of-sight path is calculated as follows:

$${Φ}_{A , pq , {n}_{m}} ( t ) = k \cdot ‖ {L}^{Tx} ( t ) {R}^{P , Tx} ( t ) {s}_{{n}_{m}}^{Tx} ( t ) + {L}^{Rx} ( t ) {R}^{P , Rx} ( t ) {s}_{{n}_{m}}^{Rx} ( t ) ‖ ;$$

424) The total phase, Φ_{pq,n}_{ₘ}(t) of the m-th sub-path of the n-th non-line-of-sight path is calculated based on the initial phase, the Doppler phase, and the antenna correction phase of the sub-path calculated in the steps 421), 422), and 423):

Φ_{pq,n}_{ₘ}(t)=Φ_{I,pq,n}_{ₘ}(t)+Φ_{D,pq,n}_{ₘ}(t)+Φ_{A,pq,n}_{ₘ}(t);
43) Original power factor

$${\tilde{C}}_{pq , {n}_{m}}^{NL} ( t )$$

of the non-line-of-sight path is calculated as follows:

$${\tilde{C}}_{pq , {n}_{m}}^{NL} ( t ) = exp ( - {τ}_{pq , {n}_{m}}^{NL} ( t ) \frac{{r}_{τ} - 1}{{r}_{τ} {σ}_{τ}} ) 1 {0}^{- {SF}_{c} / 10} ;$$

where, r_{τ} denotes a delay scalar; σ_{τ} denotes a delay spread; SF_{c} denotes cluster shadow fading following a Gaussian distribution; and the power factor

$${C}_{pq , {n}_{m}}^{NL} ( t )$$

of the non-line-ot-sight path is calculated as follows:

$${C}_{pq , {n}_{m}}^{NL} ( t ) = {\tilde{C}}_{pq , {n}_{m}}^{NL} ( t ) / {\sum }_{n = 1}^{N} {\sum }_{m = 1}^{M} {\tilde{C}}_{pq , {n}_{m}}^{NL} ( t ) .$$

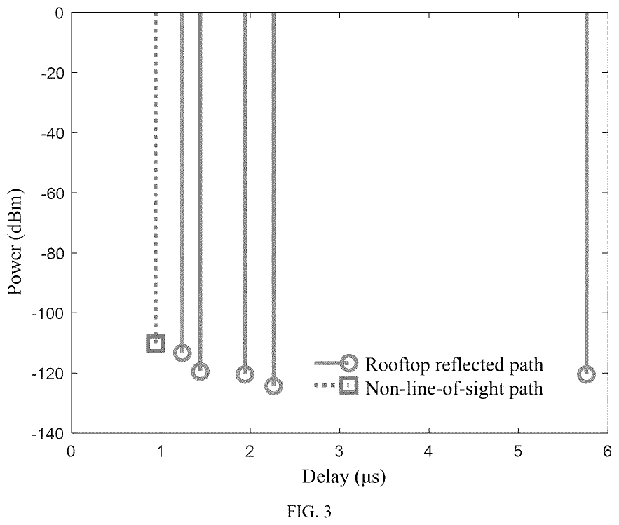

In this example, the delays and powers of the rooftop reflected path and the non-line-of-sight paths calculated are specifically shown in FIG. 3.

The step 5) specifically includes following sub-steps.

The UAV air-to-air channel model in the low-altitude scenarios is constructed as follows:

$${h}_{pq} ( t , τ ) = \sqrt{\frac{K ( t )}{K ( t ) + 1}} {h}_{pq}^{L} ( t , τ ) + \sqrt{\frac{{η}^{RSR} ( t )}{K ( t ) + 1}} {h}_{pq}^{RSR} ( t , τ ) + \sqrt{\frac{{η}^{NL} ( t )}{K ( t ) + 1}} {h}_{pq}^{NL} ( t , τ ) ;$$

where, h_{pq}(t,τ) denotes a channel impulse response between the p-th transmitter antenna and the q-th receiver antenna; t denotes a time; r denotes a delay; K(t) denotes a time-varying Rician factor; η^{RSR}(t) and η^{NL}(t) denote power coefficients of the rooftop reflected path and another non-line-of-sight path, respectively, satisfying η^{RSR}(t)+η^{NL}(t)=1; and

$${h}_{pq}^{L} ( t , τ ) ,$$

$${h}_{pq}^{RSR} ( t , τ ) ,$$

$$and$$

$${h}_{pq}^{NL} ( t , τ )$$

denote channel impulse responses of the line-of-sight path, the rooftop reflected path, and another non-line-of-sight path, respectively, and are specifically expressed as follows:

$${h}_{pq}^{L} ( t ) = {C}_{pq}^{L} ( t ) {e}^{j {Φ}_{pq}^{L} ( t )} δ ( τ - {τ}_{pq}^{L} ( t ) ) ;$$

$${h}_{pq}^{RSR} ( t ) = {C}_{pq}^{RSR} ( t ) {e}^{j {Φ}_{pq}^{RSR} ( t )} δ ( τ - {τ}_{pq}^{RSR} ( t ) ) ;$$

$${h}_{pq , {n}_{m}}^{NL} ( t ) = {\sum }_{n = 1}^{N} {\sum }_{m = 1}^{M} {C}_{pq , {n}_{m}}^{NL} ( t ) {e}^{j {Φ}_{pq , {n}_{m}}^{NL} ( t )} δ ( τ - {τ}_{pq , {n}_{m}}^{NL} ( t ) ) ;$$

N denotes a number of non-line-of-sight paths, and M denotes a number of sub-paths. Omnidirectional antennas are adopted. The attitude-dependent antenna pattern functions

$${F}_{pq}^{L} ( t )$$

$$and$$

$${F}_{pq}^{NL} ( t )$$

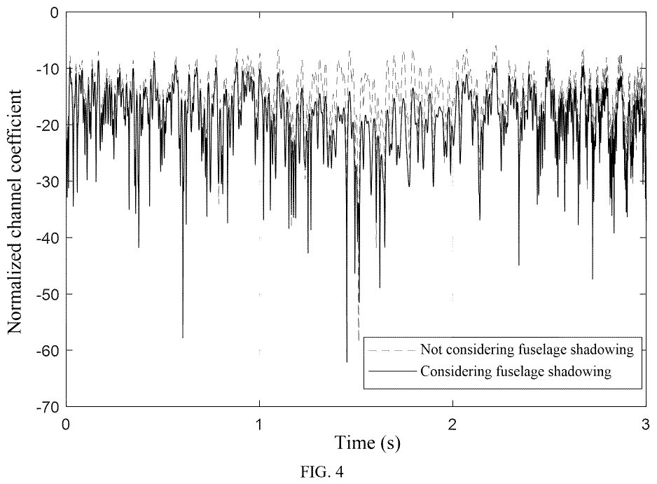

are set to 1. Parameters such as the delay, the phase, and the power factor calculated in the steps 1) to 4) are input into the low-altitude scenario UAV air-to-air channel model, and the channel coefficient is output. The channel coefficient calculated in this embodiment is specifically shown in FIG. 4.

Although some preferred embodiments of the present disclosure have been described, those skilled in the art can make changes and modifications to these embodiments once they learn the basic inventive concept. Therefore, the appended claims are intended to be interpreted as including the preferred embodiments and all changes and modifications falling within the scope of the present disclosure.

Apparently, persons skilled in the art can make various changes and modifications to the present disclosure without departing from the spirit and scope of the present disclosure. Thus, provided that these modifications and variations of the present disclosure fall within the scope of the claims of the present disclosure and their equivalents, the present disclosure will also be intended to include these modifications and variations.

1. A method for modeling and simulating an unmanned aerial vehicle (UAV) air-to-air channel in an urban low-altitude scenario, comprising following steps:
S1: calculating a delay, a total phase, and a power of a line-of-sight path between a transmitter and a receiver of a UAV in a channel model based on input position parameters of the transmitter and the receiver; and calculating a channel impulse response of the line-of-sight path based on an attitude-dependent antenna pattern function for the line-of-sight path;
S2: calculating a delay, a total phase, and a power of a rooftop reflected path in the channel model based on a communication scenario parameter; and calculating a channel impulse response of the rooftop reflected path based on an attitude-dependent antenna pattern function for a non-line-of-sight path;
S3: calculating a delay, a total phase, and a power of the non-line-of-sight path in the channel model based on height and horizontal geometric relationship parameters limiting a scatterer distribution; and calculating a channel impulse response of the non-line-of-sight path based on the attitude-dependent antenna pattern function for the non-line-of-sight path; and
S4: establishing a UAV air-to-air channel model, inputting calculation results from the steps S1 to S3, and outputting a channel coefficient, wherein the UAV air-to-air channel model is as follows:
$${h}_{pq} ( t , τ ) = \sqrt{\frac{K ( t )}{K ( t ) + 1}} {h}_{pq}^{L} ( t , τ ) + \sqrt{\frac{{η}^{RSR} ( t )}{K ( t ) + 1}} {h}_{pq}^{RSR} ( t , τ ) + \sqrt{\frac{{η}^{NL} ( t )}{K ( t ) + 1}} {h}_{pq}^{NL} ( t , τ )$$
wherein, h_{pq}(t,τ) denotes a channel impulse response between a p-th transmitter antenna and a q-th receiver antenna; t denotes a time; τ denotes a delay; K(t) denotes a RSR NL n time-varying Rician factor; η^{RSR}(t) and η^{NL}(t) denote power coefficients of the rooftop reflected path and the non-line-of-sight path, respectively, satisfying
$${η}^{RSR} ( t ) + {η}^{NL} ( t ) = 1 ;$$
$$and$$
$${h}_{pq}^{L} ( t , τ ) ,$$
$${h}_{pq}^{RSR} ( t , τ ) ,$$
$$and$$
$${h}_{pq}^{NL} ( t , τ )$$
denote the channel impulse response of the line-of-sight path, the channel impulse response of the rooftop reflected path, and the channel impulse response of the non-line-of-sight path, respectively.

2. The method for modeling and simulating the UAV air-to-air channel in the urban low-altitude scenario according to claim 1, wherein in the step S1, the calculating the delay, the total phase, and the power of the line-of-sight path between the transmitter and the receiver of the UAV in the channel model comprises:
S11: calculating positions L^{Tx/Rx}(t+Δt) of the transmitter and the receiver of the UAV at a time t+Δt:
$${L}^{Tx / Rx} ( t + Δ t ) = {L}^{Tx / Rx} ( t ) + {\int }_{t}^{t + Δ t} {v}^{Tx / Rx} ( {t}^{′} ) {dt}^{′} ;$$
wherein, v^{Tx}(t) and v^{Rx}(t) denote velocity vectors of the transmitter and the and receiver of the UAV at the time 4, respectively; and superscripts Tx and Rx denote the transmitter and the receiver, respectively;
expressing position vectors
$${L}_{p / q}^{Tx / Rx} ( t )$$
of the transmitter antenna and the receiver antenna as:
$${L}_{p / q}^{Tx / Rx} ( t ) = {L}^{Tx / Rx} ( t ) + {e}_{p / q} ( t ) ;$$
wherein, eₚ(t) denotes a vector from a center of the transmitter to a p-th antenna element; and e_{q}(t) denotes a vector from a center of the receiver to a q-th antenna element;
S12: calculating the delay
$${τ}_{pq}^{L} ( t )$$
of the line-of-sight path based on the position vectors of the transmitter antenna and the receiver antenna calculated in the step S11:
$${τ}_{pq}^{L} ( t ) = \frac{{d}_{pq}^{L} ( t )}{c} = \frac{‖ {L}_{p}^{Tx} ( t ) - {L}_{q}^{Rx} ( t ) ‖}{c} ;$$
wherein,
$${d}_{pq}^{L} ( t )$$
denotes a length of the line-of-sight path; and C denotes a speed of electromagnetic wave propagation;
S13: calculating an initial phase
$${Φ}_{I , pq}^{L} ( t )$$
of the line-of-sight path:
$${Φ}_{I , pq}^{L} ( t ) = - k \cdot {d}_{pq}^{L} ( t )$$
wherein, k=2πƒ_{c}/c denotes a wavenumber; and ƒ_{c} denotes a carrier frequency; calculating a Doppler phase
$${Φ}_{D , pq}^{L} ( t )$$
of the line-of-sight path:
$${Φ}_{D , pq}^{L} ( t ) = k \cdot {\int }_{0}^{t} ‖ {s}^{L , Tx} ( \tilde{t} ) ( {v}^{Tx} ( \tilde{t} ) - {v}^{Rx} ( \tilde{t} ) ) ‖ d \tilde{t} ;$$
wherein, s^{L,Tx}(\tilde{t}) denotes a unit vector for an angle of the line-of-sight path at the transmitter;
calculating an antenna correction phase
$${Φ}_{A , pq}^{L} ( t )$$
of the line-of-sight path:
$${Φ}_{A , pq}^{L} ( t ) = k \cdot ‖ {L}^{Tx} ( t ) {R}^{P , Tx} ( t ) {s}^{L , Tx} ( t ) + {L}^{Rx} ( t ) {R}^{P , Rx} ( t ) {s}^{L , Rx} ( t ) ‖ ;$$
wherein, R^{P,Tx/Rx}(t) denotes an attitude matrix of the transmitter or the receiver of the UAV; and s^{L,Rx}(t) denotes a unit vector for an angle of the line-of-sight path at the receiver; calculating the total phase
$${Φ}_{pq}^{L} ( t )$$
of the line-of-sight path:
$${Φ}_{pq}^{L} ( t ) = {Φ}_{I , pq}^{L} ( t ) + {Φ}_{D , pq}^{L} ( t ) + {Φ}_{A , pq}^{L} ( t ) ;$$
S14: defining a fuselage structure parameter set U:
U={Θ^{l},Θ^{b}Θ^{d},d^{a},d^{w}l^{a},l^{xy},l^{c}};
wherein, Θ^{l} denotes a leading edge sweep angle; Θ^{b} denotes a trailing edge sweep angle; Θ^{d} denotes a dihedral angle; d^{a} denotes a fuselage width; d^{w} denotes a wingspan; l^{a} denotes a fuselage length; l^{xy} denotes a vertical distance of an antenna from an x-y plane; and l^{c} denotes a wing chord length;
calculating a position vector Lᵢ(t) of a fuselage diffraction point:
$${L}_{i} ( t ) = {L}_{p / q}^{Tx / Rx} ( t ) + {e}_{p / q , i} ;$$
wherein, denotes an i-th diffraction path; and e_{p/q,i} denotes a vector from the p-th i transmitter antenna element or the q-th receiver antenna element to a fuselage edge;
defining a dimensionless parameter εᵢ(t):
$${ε}_{i} = \sqrt{\frac{2 {d}_{i} ( t ) \cdot {Θ}_{i} ( t )}{λ}} ;$$
wherein, dᵢ(t) denotes a vertical distance from the fuselage diffraction point to a line connecting the transmitter and the receiver; and Θᵢ(t) denotes an angle formed by the transmitter, the fuselage diffraction point, and the receiver;
calculating a power factor
$${C}_{pq}^{L} ( t )$$
of the line-of-sight path considering a fuselage shadowing effect:
$${C}_{pq}^{L} ( t ) = \{ \begin{matrix}{10}^{- ( 32.4 + 20 lg {d}_{pq}^{L} ( t ) + 20 lg {f}_{c} ) / 20} , & {ε}_{i} ( t ) < {ε}_{1} \\ {\sum }_{i} {10}^{- ( {J}_{0} + 20 lg {d}_{pq}^{L} ( t ) + 20 lg {f}_{c} + 20 log ( \sqrt{{( {ε}_{i} ( t ) - 0.1 )}^{2} + 1} + {ε}_{i} ( t ) - 0.1 ) ) / 20} , & {ε}_{1} \leq {ε}_{i} ( t ) \leq {ε}_{2} \\ 0 & Others\end{matrix}$$
wherein, ε₁ denotes a threshold for distinguishing between no shadowing and partial fuselage shadowing based on a diffraction attenuation degree; ε₂ denotes a threshold for distinguishing between partial fuselage shadowing and full shadowing based on the diffraction attenuation degree; and J₀ is a correction constant.

3. The method for modeling and simulating the UAV air-to-air channel in the urban low-altitude scenario according to claim 1, wherein in the step S1, the channel impulse response of the line-of-sight path is:
$${h}_{pq}^{L} ( t ) = {F}_{pq}^{L} ( t ) {C}_{pq}^{L} ( t ) {e}^{j {Φ}_{pq}^{L} ( t )} δ ( τ - {τ}_{pq}^{L} ( t ) ) ;$$
wherein, δ(⋅) denotes a Dirac function;
$${C}_{pq}^{L} ( t )$$
denotes a power factor of the line-of-sight path;
$${Φ}_{pq}^{L} ( t )$$
denotes the total phase of the line-of-sight path;
$${τ}_{pq}^{L} ( t )$$
denotes the delay of the line-of-sight path; and
$${F}_{pq}^{L} ( t )$$
denotes the attitude-dependent antenna pattern function for the line-of-sight path:
$${F}_{pq}^{L} ( t ) = {[ \begin{matrix}{F}_{p , V}^{Tx} ( {s}^{L , Tx} ( t ) , {R}^{P , Tx} ( t ) ) \\ {F}_{p , H}^{Tx} ( {s}^{L , Tx} ( t ) , {R}^{P , Tx} ( t ) )\end{matrix} ]}^{T} [ \begin{matrix}{e}^{j {Φ}_{L}^{VV}} & 0 \\ 0 & {e}^{j {Φ}_{L}^{HH}}\end{matrix} ] [ \begin{matrix}{F}_{q , V}^{Rx} ( {s}^{L , Rx} ( t ) , {R}^{P , Rx} ( t ) ) \\ {F}_{q , H}^{Rx} ( {s}^{L , Rx} ( t ) , {R}^{P , Rx} ( t ) )\end{matrix} ]$$
wherein,
$${F}_{p , V}^{T x} ( \cdot )$$
denotes an antenna pattern component of the transmitter in a vertical plane;
$${F}_{q , V}^{R x} ( \cdot )$$
denotes an antenna pattern component of the receiver in the vertical plane;
$${F}_{p , H}^{T x} ( \cdot )$$
denotes an antenna pattern component of the transmitter in a horizontal plane;
$${F}_{q , H}^{R x} ( \cdot )$$
denotes an antenna pattern component of the receiver in the horizontal plane;
$${Φ}_{L}^{VV}$$
denotes a vertical transmit-vertical receive polarization mode, and
$${Φ}_{L}^{HH}$$
denotes a horizontal transmit-horizontal receive polarization mode, describing a polarization phase variation of the line-of-sight path; and R^{P,Tx/Rx}(t) denotes an attitude matrix of the transmitter or the receiver of the UAV.

4. The method for modeling and simulating the UAV air-to-air channel in the urban low-altitude scenario according to claim 1, wherein in the step S2, the calculating the delay, the total phase, and the power of the rooftop reflected path in the channel model based on the communication scenario parameter comprises:
S21: calculating a length
$${d}_{p q}^{R S R} ( t )$$
of the rooftop reflected path:
$${d}_{p q}^{R S R} ( t ) = \sqrt{{\sum }_{j = x , y , z} {( {L}_{p , j}^{Tx} ( t ) - {L}_{j}^{R S R} ( t ) )}^{2}} + \sqrt{{\sum }_{j = x , y , z} {( {L}_{j}^{R S R} ( t ) - {L}_{q , j}^{Rx} ( t ) )}^{2}} ;$$
wherein,
$${L}_{q , j}^{R x} ( t )$$
denotes a coordinate component for a position vector of the receiver antenna;
$${L}_{p , j}^{T x} ( t )$$
denotes a coordinate component for a position vector of the transmitter antenna;
$${L}^{R S R} ( t ) = [ \begin{matrix}{L}_{x}^{R S R} ( t ) & {L}_{y}^{R S R} ( t ) & {L}_{z}^{R S R} ( t )\end{matrix} ]$$
denotes coordinates of a rooftop reflection point;
$${L}_{j}^{R S R} ( t )$$
denotes a coordinate component of the rooftop reflection point; and a coordinate system is established with projection of a line connecting the transmitter and the receiver onto a horizontal plane as an x-axis, wherein a y-axis component is set to 0, and remaining components are calculated based on a triangle similarity property as follows:
$${L}_{x}^{R S R} ( t ) = ( \frac{‖ {L}_{z}^{R S R} ( t ) - {L}_{q , z}^{R x} ( t ) ‖}{‖ {L}_{p , z}^{T x} ( t ) + {L}_{q , z}^{R x} ( t ) - 2 {L}_{z}^{R S R} ( t ) ‖} \cdot ‖ {L}_{p , x}^{T x} ( t ) - {L}_{q , x}^{R x} ( t ) ‖ - ‖ {L}_{p , x}^{T x} ( t ) ‖ ) {e}_{x} ;$$
$${L}_{z}^{R S R} ( t ) = {h}^{R S R} {e}_{z} ;$$
wherein, eₓ denotes an x-axis unit vector; e_{z} denotes a z-axis unit vector; and h^{RSR} denotes a height of the rooftop reflection point above a ground, with a probability density function as follows:
$$P ( {h}^{R S R} ) = \{ \begin{matrix}- {p}_{α} , & {h}^{RSR} = 0 \\ {p}_{α} \frac{{h}^{RSR}}{{γ}_{A}^{2}} exp ( - \frac{{( {h}^{RSR} )}^{2}}{2 {γ}_{A}^{2}} ) , & {h}^{RSR} > 0\end{matrix} ;$$
wherein, P_{α} denotes a proportion of land covered by a building, and γ_{A} denotes an average building height;
calculating the delay
$${τ}_{p q}^{R S R} ( t )$$
based on the length of the rooftop reflected path:
$${τ}_{pq}^{RSR} ( t ) = \frac{{d}_{pq}^{RSR} ( t )}{c} ;$$
wherein, [symbol] denotes a speed of electromagnetic wave propagation; and
$${d}_{pq}^{RSR} ( t )$$
denotes the length of the rooftop reflected path;
S22, calculating an initial phase
$${Φ}_{I , pq}^{RSR} ( t )$$
of the rooftop reflected path:
$${Φ}_{I , pq}^{RSR} ( t ) = - k \cdot {d}_{pq}^{RSR} ( t ) ;$$
wherein, k=2πƒ_{c}/c denotes a wavenumber; and ƒ_{c} denotes a carrier frequency; calculating a Doppler phase
$${Φ}_{D , pq}^{RSR} ( t )$$
of the rooftop reflected path:
$${Φ}_{D , pq}^{RSR} ( t ) = k \cdot {\int }_{0}^{t} ‖ {s}^{RSR , Tx} ( {t}^{\%} ) {v}^{Tx} ( {t}^{\%} ) + {s}^{RSR , Rx} ( {t}^{\%} ) {v}^{Rx} ( {t}^{\%} ) ‖ {dt}^{\%} ;$$
wherein, s^{RSR,Tx}(t) denotes a unit direction vector of the rooftop reflected path at the transmitter; s^{RSR,Rx}(t) denotes a unit direction vector of the rooftop reflected path at the receiver; and v^{Tx}(\tilde{t}) and v^{Rx}(\tilde{t}) denote velocity vectors of the transmitter and the receiver of the UAV at a time l %, respectively;
calculating an antenna correction phase
$${Φ}_{A , pq}^{RSR} ( t )$$
of the rooftop reflected path:
$${Φ}_{A , pq}^{RSR} ( t ) = k \cdot ‖ {L}^{Tx} ( t ) {R}^{P , Tx} ( t ) {s}^{RSR , Tx} ( t ) + {L}^{Rx} ( t ) {R}^{P , Rx} ( t ) {s}^{RSR , Rx} ( t ) ‖ ;$$
wherein, L^{Tx/Rx}(t) denotes a position of the transmitter or the receiver of the UAV at the time t; and R^{P,Tx/Rx}(t) denotes an attitude matrix of the transmitter or the receiver of the UAV;
calculating the total phase
$${Φ}_{pq}^{RSR} ( t )$$
of the rooftop reflected path:
$${Φ}_{pq}^{RSR} ( t ) = {Φ}_{I , pq}^{RSR} ( t ) + {Φ}_{D , pq}^{RSR} ( t ) + {Φ}_{A , pq}^{RSR} ( t ) ;$$
S23, calculating a power factor
$${C}_{pq}^{RSR} ( t )$$
of the rooftop reflected path:
$${C}_{pq}^{RSR} ( t ) = {Γ}^{RSR} ( t ) {10}^{- ( 32.4 + 20 {lgd}_{pq}^{RSR} ( t ) + 20 {lgf}_{c} ) / 20} ;$$
wherein, Γ^{SRS}(t) denotes a complex reflection coefficient.

5. The method for modeling and simulating the UAV air-to-air channel in the urban low-altitude scenario according to claim 1, wherein in the step S2, the channel impulse response of the rooftop reflected path is:
$${h}_{pq}^{RSR} ( t ) = {F}_{pq}^{NL} ( t ) {C}_{pq}^{RSR} ( t ) {e}^{j {Φ}_{pq}^{RSR} ( t )} δ ( τ - {τ}_{pq}^{RSR} ( t ) ) ;$$
wherein, N denotes a number of non-line-of-sight paths;
$${C}_{pq}^{RSR} ( t )$$
denotes a power factor of the rooftop reflected path;
$${Φ}_{pq}^{RSR} ( t )$$
denotes the total phase of the rooftop reflected path;
$${τ}_{pq}^{RSR} ( t )$$
denotes the delay of the rooftop reflected path; and
$${F}_{pq}^{NL} ( t )$$
denotes the attitude-dependent antenna pattern function for the non-line-of-sight path;
$${F}_{pq}^{NL} ( t ) = {[ \begin{matrix}{F}_{p , V}^{Tx} ( {s}_{{n}_{m}}^{Tx} ( t ) , {R}^{P , Tx} ( t ) ) \\ {F}_{p , H}^{Tx} ( {s}_{{n}_{m}}^{Tx} ( t ) , {R}^{P , Tx} ( t ) )\end{matrix} ]}^{T} [ \begin{matrix}{e}^{j {Φ}_{{n}_{m}}^{VV}} & \sqrt{{κ}_{{n}_{m}}^{- 1}} {e}^{j {Φ}_{{n}_{m}}^{VH}} \\ \sqrt{{κ}_{{n}_{m}}^{- 1}} {e}^{j {Φ}_{{n}_{m}}^{HV}} & {e}^{j {Φ}_{{n}_{m}}^{HH}}\end{matrix} ] [ \begin{matrix}{F}_{q , V}^{Rx} ( {s}_{{n}_{m}}^{Rx} ( t ) , {R}^{P , Rx} ( t ) ) \\ {F}_{q , H}^{Rx} ( {s}_{{n}_{m}}^{Rx} ( t ) , {R}^{P , Rx} ( t ) )\end{matrix} ] ;$$
wherein,
$${F}_{p , V}^{Tx} ( \cdot )$$
denotes an antenna pattern component of the transmitter in a vertical plane;
$${F}_{q , V}^{Rx} ( \cdot )$$
denotes an antenna pattern component of the receiver in the vertical plane;
$${F}_{p , H}^{Tx} ( \cdot )$$
denotes an antenna pattern component of the transmitter in a horizontal plane;
$${F}_{q , H}^{Rx} ( \cdot )$$
denotes an antenna pattern component of the receiver in the horizontal plane;
$${Φ}_{{n}_{m}}^{VV}$$
denotes an initial phase for vertical transmit-vertical receive polarization of the non-line-of-sight path;
$${Φ}_{{n}_{m}}^{HH}$$
denotes an initial phase for horizontal transmit-horizontal receive polarization of the non-line-of-sight path;
$${Φ}_{{n}_{m}}^{VH}$$
denotes an initial phase for vertical transmit-horizontal receive polarization of the non-line-of-sight path;
$${Φ}_{{n}_{m}}^{HV}$$
denotes an initial phase for horizontal transmit-vertical receive polarization of the non-line-of-sight path; [symbol] denotes a cross-polarization power ratio; and R^{P,Tx/Rx}(t) denotes an attitude matrix of the transmitter or the receiver of the UAV.

6. The method for modeling and simulating the UAV air-to-air channel in the urban low-altitude scenario according to claim 1, wherein in the step S3, the calculating the delay, the total phase, and the power of the non-line-of-sight path in the channel model based on the geometric relationship parameters limiting the scatterer distribution comprises:
S31: calculating a length d_{pq,n}_{ₘ}(t) of an m-th sub-path of an n-th non-line-of-sight path:
$${d}_{pq , {n}_{m}} ( t ) = ‖ {L}_{p}^{Tx} ( t ) - {L}_{{n}_{m}} ( t ) ‖ + ‖ {L}_{q}^{Rx} ( t ) - {L}_{{n}_{m}} ( t ) ‖ ;$$
wherein,
$${L}_{p}^{Tx} ( t )$$
represents a position vector of the P-th transmitter antenna element at the time t, and
$${L}_{q}^{Rx} ( t )$$
represents a position vector of the q-th receiver antenna element at the time t; Lₙ_{ₘ}(t) denotes a coordinate vector of a scattering point, expressed as Lₙ_{ₘ}(t)=[L_{x,n}_{ₘ}(t),L_{y,n}_{ₘ}(t),L_{z,n}_{ₘ}(t)] and calculated as follows: as
$$\{ \begin{matrix}\sqrt{{( {L}_{x , {n}_{m}} ( t ) )}^{2} + {( {L}_{y , {n}_{m}} ( t ) )}^{2}} = R \\ ‖ {L}_{z , {n}_{m}} ( t ) ‖ = H , H \leq max \{ {L}^{Tx} ( t ) , {L}^{Rx} ( t ) \} ;\end{matrix}$$
wherein, R denotes a horizontal distance parameter limiting the scatterer distribution; H denotes a vertical distance parameter limiting the scatterer distribution; and L^{Tx/Rx}(t) denotes a position of the transmitter or the receiver of the UAV at the time t;
calculating a delay
$${τ}_{pq , {n}_{m}}^{NL} ( t )$$
of the m-th sub-path of the n-th non-line-of-sight path:
$${τ}_{pq , {n}_{m}}^{NL} ( t ) = \frac{{d}_{pq , {n}_{m}} ( t )}{c} ;$$
S32: calculating an initial phase Φ_{I,pq,n}_{ₘ}(t) of the m-th sub-path of the n-th non-line-of-sight path:
Φ_{I,pq,n}_{ₘ}(t)=−k·d_{pq,n}_{ₘ}(t);
wherein, k=2πƒ_{c}/C denotes a wavenumber; and ƒ_{c} denotes a carrier frequency;
calculating a Doppler phase Φ_{D,pq,n}_{ₘ}(t) of the m-th sub-path of the n-th non-line-of-sight path:
$${Φ}_{D , pq , {n}_{m}} ( t ) = k \cdot {\int }_{0}^{t} ‖ {s}_{{n}_{m}}^{Tx} ( {t}^{\%} ) {v}^{Tx} ( {t}^{\%} ) + {s}_{{n}_{m}}^{Rx} ( {t}^{\%} ) {v}^{Rx} ( {t}^{\%} ) ‖ {dt}^{\%} ;$$
wherein,
$${s}_{{n}_{m}}^{Tx / Rx} ( t )$$
denotes a unit vector for an angle of the m-th sub-path of the n-th non-line-of-sight path at the transmitter or the receiver; and v^{Tx}(\tilde{t}) and v^{Rx}(\tilde{t}) denote velocity vectors of the transmitter and the receiver of the UAV at a time l %, respectively;
calculating an antenna correction phase Φ_{A,pq,n}_{ₘ}(t) of the m-th sub-path of the n-th non-line-of-sight path:
$${Φ}_{A , pq , {n}_{m}} ( t ) = k \cdot {\int }_{0}^{t} ‖ {L}^{Tx} ( t ) {R}^{P , Tx} ( t ) {s}_{{n}_{m}}^{Tx} ( t ) + {L}^{Rx} ( t ) {R}^{P , Rx} ( t ) + {s}_{{n}_{m}}^{Rx} ( t ) ) ‖ ;$$
wherein, R^{P,Tx/Rx}(t) denotes an attitude matrix of the transmitter or the receiver of the UAV;
calculating a total phase Φ_{pq,n}_{ₘ}(t) of the m-th sub-path of the n-th non-line-of-sight path:
$${Φ}_{pq , {n}_{m}} ( t ) = {Φ}_{I , pq , {n}_{m}} ( t ) + {Φ}_{D , pq , {n}_{m}} ( t ) + {Φ}_{A , pq , {n}_{m}} ( t ) ;$$
S33, calculating an original power factor
$${C}_{pq , {n}_{m}}^{\% NL} ( t )$$
of the non-line-of-sight path:
$${C}_{pq , {n}_{m}}^{\% NL} ( t ) = exp ( - {τ}_{pq , {n}_{m}}^{NL} ( t ) \frac{{r}_{τ} - 1}{{r}_{τ} {σ}_{τ}} ) {10}^{- {SF}_{c} / 10} ;$$
wherein, r_{τ} denotes a delay scalar; σ_{τ} denotes a delay spread; SF_{c} denotes cluster shadow fading following a Gaussian distribution; and a power factor
$${C}_{pq , {n}_{m}}^{NL} ( t )$$
of the non-line-of-sight path is calculated as follows:
$${C}_{pq , {n}_{m}}^{NL} ( t ) = {C}_{pq , {n}_{m}}^{\% NL} ( t ) / {\sum }_{n = 1}^{N} {\sum }_{m = 1}^{M} {C}_{pq , {n}_{m}}^{\% NL} ( t )$$
wherein, N denotes a number of non-line-of-sight paths, and M denotes a number of sub-paths.

7. The method for modeling and simulating the UAV air-to-air channel in the urban low-altitude scenario according to claim 1, wherein in the step S3, the channel impulse response of the non-line-of-sight path is:
$${h}_{pq , {n}_{m}}^{NL} ( t ) = {F}_{pq}^{NL} ( t ) {\sum }_{n = 1}^{N} {\sum }_{m = 1}^{M} {C}_{pq , {n}_{m}}^{NL} ( t ) {e}^{j {Φ}_{pq , {n}_{m}}^{NL} ( t )} δ ( τ - {τ}_{pq , {n}_{m}}^{NL} ( t ) ) ;$$
wherein, N denotes a number of non-line-of-sight paths; M denotes a number of sub-paths;
$${C}_{pq , {n}_{m}}^{NL} ( t )$$
denotes a power factor of the non-line-of-sight path;
$${Φ}_{pq , {n}_{m}}^{NL} ( t )$$
denotes a phase component of the non-line-of-sight path;
$${τ}_{pq , {n}_{m}}^{NL} ( t )$$
denotes the delay of the non-line-of-sight path; and
$${F}_{pq}^{NL} ( t )$$
denotes the attitude-dependent antenna pattern function.
